(19) United States
(12) Patent Application Publication
(10) Pub. No.: US 2015/0309632 A1
(43) Pub. Date: Oct. 29, 2015

(54) RESIN COMPOSITION, DEVICE FOR IMAGE DISPLAY, AND METHOD FOR MANUFACTURING DEVICE FOR IMAGE DISPLAY

(71) Applicant: HITACHI CHEMICAL COMPANY, LTD., Chiyoda-ku, Tokyo (JP)

(72) Inventors: Yuuki MIYAMOTO, Hitachi-shi, Ibaraki (JP); Tomohiro HIRATA, Ichihara-shi, Chiba (JP); Youichi Kimura, Hitachi-shi, Ibaraki (JP); Keishi HAMADA, Hitachi-shi, Ibaraki (JP); Tetsuya OKAZAKI, Hitachi-shi, Ibaraki (JP); Hiroka SHINDOU, Hitachi-shi, Ibaraki (JP); Masayuki WADA, Hitachi-shi, Ibaraki (JP); Tomohiro HORINOUCHI, Hitachi-shi, Ibaraki (JP)

(21) Appl. No.: 14/442,866

(22) PCT Filed: Nov. 14, 2013
(86) PCT No.: PCT/JP2013/080834

§ 371 Date: May 14, 2015

(30) Foreign Application Priority Data
Nov. 15, 2012 (JP) 2012-251495

(51) Int. Cl. G06F 3/041; G02F 1/1333; C08K 5/372; G09G 3/36; C08K 5/13

(52) U.S. Cl. CPC G06F 3/0412; G09G 3/36; C08K 5/13; C08K 5/372; G02F 1/133308; G06F 2203/04101; G02F 2001/133331

(57) ABSTRACT

To provide a photocurable liquid resin composition which may be suitably applied for the purpose of filling a space between a protective panel and an image display unit or the like in an image display device, has an appropriate viscosity, is excellent in curing properties at a low dose and shaded part curing properties, is favorable in moist heat resistance reliability of a cured material, and is able to not only sufficiently suppress bleedout but also enhance resistance to yellowing after photocuring when used as a structural member of an image display device; an image display device using the same; and a method for manufacturing an image display device.

Disclosed is a photocurable liquid resin composition including (A) a compound having a (meth)acryloyl group, (B) a photopolymerization initiator, (C) a plasticizer, and (D) an antioxidant, the component (D) including a compound having a hindered phenol structure in a molecule thereof.

### TECHNICAL FIELD

The present invention relates to a photocurable liquid resin composition, an image display device using the same, and a method for manufacturing an image display device.

### BACKGROUND ART

As representative image display devices having an image display panel mounted thereon, there are exemplified liquid crystal display devices. The liquid crystal display devices have a liquid crystal display panel composed of a liquid crystal cell, an optical film stuck on each of outer surfaces thereof, such as a polarizing plate, and the like. This liquid crystal cell is constituted such that two sheets of glass substrates each having a transparent electrode, a pixel pattern, and the like formed on the surface thereof and having a thickness of about 1 mm are disposed at a gap of about several microns, and a liquid crystal is filled in this gap, followed by sealing.

The above-described liquid crystal display panel is thin and apt to be scratched, and thus, particularly, in mobile phones, game consoles, digital cameras, onboard applications, and the like, liquid crystal display devices having a structure in which a transparent front plate (hereinafter also referred to as “protective panel” or “transparent protective substrate”) is provided at a certain space in front of the above-described liquid crystal display panel are typically used.

Furthermore, in recent years, in image display devices such as mobile phones, game consoles, digital cameras, and onboard parts, and moreover, notebook personal computers, desktop personal computers, monitors for personal computers, and the like, a touch panel has been being mounted. Such a touch panel-mounted image display device has a laminate structure of a front plate, a touch panel, and a liquid crystal display panel, and air intervenes between the front plate and the touch panel and between the touch panel and the liquid crystal display panel. Such air causes scattering of light, resulting in lowering of contrast or brightness.

In addition, as a current large-sized liquid crystal display device, those in which the surface of a polarizing plate provided in front of the liquid crystal display device is subjected to an antiglare (AG) treatment for the purpose of reflection reduction are typical. In this large-sized liquid crystal display device, a measure regarding impact absorption is not adopted for the AG-treated surface, the impact resistance is brought by a structure as a set of the whole of the liquid crystal display panel and the liquid crystal display device.

As for problems of a large-sized liquid crystal display device of this construction, it may be considered that an image is seen blurred due to the AG treatment; that when touching the surface, the liquid crystal display panel bends, whereby an image is disordered; that the dirts come out hardly due to the AG treatment, so that when rubbed strongly, the surface is apt to be scratched; and that in addition thereto, following an increase in size of the liquid crystal display panel in the future, the impact resistance of the liquid crystal display panel is lowered.

Then, it may be considered to place a front plate having been subjected to an antireflection (AR) treatment in front of the liquid crystal display panel, thereby intending to dissolve the defects originated from the AG treatment.

In this case, when a space between the front plate and the liquid crystal display panel is air, a lowering of transmittance, a lowering of image quality to be caused due to ghost reflections, and the like may be considered, and thus, it is proposed to fill the space with a resin or the like (see, for example, PTL 1).

Meanwhile, in the case of using a thermosetting resin composition as a resin composition for filling the above-described space of the image display device (for example, a space between a protective panel and an image display unit, a space between a protective panel and a touch panel, or a space between a touch panel and an image display unit), the resin composition is restricted by a heat-resistant temperature as a structural member of the image display device. For that reason, it is investigated to use a photocurable liquid resin composition as the resin composition for filling the space of the image display device (see, for example, PTL 2).

### CITATION LIST

### Patent Literature

### PTL 1: JP2008-83491A

### PTL 2: JP2009-001654A

### SUMMARY OF INVENTION

### Technical Problem

However, in the case of applying the photocurable liquid resin composition as described in PTL 2 to the above-described application, a problem of “bleedout” such that the above-described resin composition bleeds out under a high-temperature condition or a high-temperature and high-humidity condition after photocuring is caused.

An object of the present invention is to provide a photocurable liquid resin composition capable of thoroughly suppressing the bleedout after photocuring, an image display device using the same, and a method for manufacturing an image display device.

Furthermore, another object of the present invention is to provide a photocurable liquid resin composition which may be suitably applied for the purpose of filling a space between a protective panel and an image display unit or the like in an image display device, has an appropriate viscosity, is excellent in curing properties at a low dose and curing properties in a shadow part such as a back side portion of a shaded part (hereinafter also referred to as “shaded part curing properties”), is favorable in moist heat resistance reliability of a cured material thereof, and is able to suppress the generation of display unevenness even when used as a structural member of an image display device, an image display device using the same, and a method for manufacturing an image display device.

### Solution to Problem

The present inventors have found that among photocurable liquid resin compositions, a resin composition containing a specified antioxidant solves the above-described problems, leading to accomplishment of the present invention.

Specifically, the present invention provides the following [1] to [12].

[1] A photocurable liquid resin composition including (A) a compound having a (meth)acryloyl group, (B) a photopolymerization initiator, (C) a plasticizer, and (D) an antioxidant, the component (D) including (D1) a compound having a hindered phenol structure in a molecule thereof.
[2] The photocurable liquid resin composition as set forth above in [1], wherein the compound of (D1) is a compound further having a thioether structure.
[3] The photocurable liquid resin composition as set forth above in [1], which further includes (D2) a compound having a thioether structure in addition to the compound of (D1) as the component (D).
[4] The photocurable liquid resin composition as set forth above in any one of [1] to [3], which includes an isoprene polymer having a (meth)acryloyl group as the component (A).
[5] The photocurable liquid resin composition as set forth above in any one of [1] to [4], wherein a content of the component (A) is 10% by mass to 90% by mass relative to the total amount of the resin composition.
[6] The photocurable liquid resin composition as set forth above in any one of [1] to [5], which includes (A1) a polymer having a (meth)acryloyl group in a molecule thereof and (A2) a monomer having one (meth)acryloyl group in a molecule thereof as the component (A).
[7] The photocurable liquid resin composition as set forth above in [6], wherein a content of the component (A2) in the total amount of the resin composition is 0.5% by mass to 10% by mass.
[8] The photocurable liquid resin composition as set forth above in any one of [1] to [7], which does not substantially contain an organic solvent and has a viscosity at 25° C. of from 5.0×10² mPa·s to 5.0×10³ mPa·s.
[9] An image display device having a laminate structure including an image display unit having an image display part, a protective panel, and a resin layer existent between the image display unit and the protective panel, the resin layer being composed of a cured material of the resin composition as set forth above in any one of [1] to [8].
[10] An image display device having a laminate structure including an image display unit having an image display part, a touch panel, a protective panel, and a resin layer existent between the image display unit and the touch panel, or between the touch panel and the protective panel, the resin layer being composed of a cured material of the resin composition as set forth above in any one of [1] to [8].
[11] A method for manufacturing an image display device including an image display unit and a protective panel, the method including a step of allowing the resin composition as set forth above in any one of [1] to [8] to intervene between the image display unit and the protective panel; and a step of performing irradiation with light from the side of the protective panel surface, to cure the resin composition.
[12] A method for manufacturing an image display device including an image display unit, a touch panel, and a protective panel, the method including a step of allowing the resin composition as set forth above in any one of [1] to [8] to intervene between the image display unit and the touch panel, or between the touch panel and the protective panel; and a step of performing irradiation with light from the side of the protective panel surface, to cure the resin composition.

### Advantageous Effects of Invention

The photocurable liquid resin composition of the present invention may be suitably applied for the purpose of filling a space between a protective panel and an image display unit or the like in an image display device and is able to suppress bleedout. In addition, the photocurable liquid resin composition of the present invention is excellent in shaded part curing properties and favorable in moist heat resistance reliability of a cured material.

### BRIEF DESCRIPTION OF DRAWINGS

FIG. 1 is a side cross-sectional view schematically showing an embodiment of a liquid crystal display device that is an example of the image display device of the present invention.

FIG. 2 is a side cross-sectional view schematically showing a liquid crystal display device having a touch panel mounted thereon, which is an embodiment of a liquid crystal display device that is an example of the image display device of the present invention.

FIG. 3 is a side cross-sectional view of a test sample used for evaluating shaded part curing properties.

### DESCRIPTION OF EMBODIMENTS

The photocurable liquid resin composition (hereinafter also referred to simply as “resin composition”) of the present invention, and a method for manufacturing an image display device and an image display device each using the same are hereunder described in more detail according to embodiments. It is to be noted that it should not be construed that the present invention is limited to these embodiments.

It is to be noted that in the drawings, the same or equivalent elements are designated by the same symbols, and their redundant description is omitted.

It is to be noted that in the present specification, the term “(meth)acrylate” means an “acrylate” and a “methacrylate”. Similarly, the term “(meth)acryl” means an “acryl” and a “methacryl”, and the term “(meth)acryloyl” means an “acryloyl” and a “methacryloyl”.

In addition, in the present specification, the molecular weight of the resin is a value resulting from measurement by gel permeation chromatography (GPC) using THF as a solvent and conversion using a calibration curve of standard polystyrene, and specifically, it means a value measured according to a method described in the Examples. In addition, the number average molecular weight, the weight average molecular weight, and the degree of dispersion are defined as follows.

(a) Number average molecular weight (Mn)

Mn=Σ(Nᵢ/Mᵢ)/ΣNᵢ=ΣXᵢMᵢ (Xᵢ=molar fraction of the molecule having a molecular weight Mᵢ=Nᵢ/ΣNᵢ)

(b) Weight average molecular weight (Mw)

Mw=Σ(Nᵢ/Mᵢ²)/ΣNᵢMᵢ=ΣWᵢMᵢ (Wᵢ=weight fraction of the molecule having a molecular weight Mᵢ=NᵢMᵢ/ΣNᵢMᵢ)

(c) Molecular weight distribution (degree of dispersion)

Degree of dispersion=Mw/Mn

The photocurable liquid resin composition of the present invention includes (A) a compound having a (meth)acryloyl group, (B) a photopolymerization initiator, (C) a plasticizer, and (D) an antioxidant, the component (D) including a compound having a hindered phenol structure.

Next, each of the components of the resin composition is described in detail.

### [Component (A): Compound Having a (Meth)Acryloyl Group]

The photocurable liquid resin composition of the present invention contains a compound having a (meth)acryloyl group as the component (A).

From the viewpoints of curing properties and moist heat resistance reliability, a content of the component (A) is preferably 10% by mass or more, more preferably 12% by mass or more, and still more preferably 15% by mass or more relative to the total amount of the resin composition. From the viewpoints of curing shrinkage ratio and modulus of elasticity, the content of the component (A) is preferably 95% by mass or less, more preferably 90% by mass or less, and still more preferably 60% by mass or less relative to the total amount of the resin composition, and taking adhesive strength into consideration, the content of the component (A) is especially preferably 40% by mass or less.

Examples of the compound having a (meth)acryloyl group include a polymer having a (meth)acryloyl group in a molecule thereof (hereinafter also referred to as “component (A1)”) and a monomer having one (meth)acryloyl group in a molecule thereof (hereinafter also referred to as “component (A2)”), and from the viewpoint of regulating the viscosity of the resin composition, it is preferred to use the component (A1) and the component (A2) in combination.

The component (A1) and the component (A2) are hereunder described.

### <Component (A1): Polymer Having a (Meth)Acryloyl Group in a Molecule Thereof>

Examples of the polymer having a (meth)acryloyl group in a molecule thereof, that is the component (A1), include a polyester oligomer having a (meth)acryloyl group, a urethane polymer having a (meth)acryloyl group, polyethylene glycol mono(meth)acrylate, polyethylene glycol di(meth)acrylate, polypropylene glycol mono(meth)acrylate, polypropylene glycol di(meth)acrylate, a butadiene polymer having a (meth)acryloyl group, an isoprene polymer having a (meth)acryloyl group, and the like.

Of these, from the viewpoints of transparency, resistance to yellowing, and a balance of various properties, an isoprene polymer having a (meth)acryloyl group is preferred.

As the isoprene polymer having a (meth)acryloyl group, for example, a compound represented by the following general formula (2) is preferred.

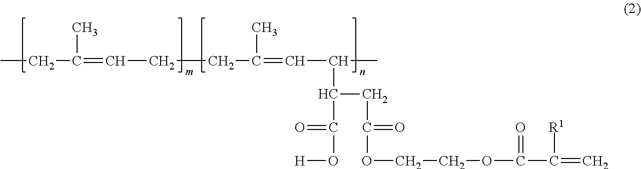

In the foregoing general formula (2), m represents a number of 50 to 1,000; n represents a number of 1 to 5; and R¹ represents a hydrogen atom or a methyl group.

Though m is 50 to 1,000, it is preferably 100 or more, preferably 150 or more, and still more preferably 200 or more. Furthermore, m is more preferably 800 or less, more preferably 700 or less, and still more preferably 600 or less.

Though n is 1 to 5, it is preferably 1.5 or more, and more preferably 2.0 or more. Furthermore, n is preferably 4.0 or less, more preferably 3.5 or less, and still more preferably 3.0 or less.

Examples of commercially available products of the compound represented by the foregoing general formula (2) include UC-102 and UC-203 (the both are trade name, manufactured by Kuraray Co., Ltd.), and the like.

From the viewpoint that the curing shrinkage ratio of the resin composition and the modulus of elasticity can be more reduced, an average number of functional groups in the component (A1) is preferably 1.5 or more, and more preferably 2.0 or more. From the same viewpoint, the average number of functional groups in the component (A1) is preferably 4.0 or less, more preferably 3.5 or less, and still more preferably 3.0 or less.

It is to be noted that the “number of functional groups” represents a number of functional groups ((meth)acryloyl groups) in one molecule of the component (A1), and the “average number of functional groups” represents an average value of the number of functional groups per molecule in the whole of the component (A1).

From the viewpoints of viscosity and workability after compounding and toughness and modulus of elasticity of a cured material, the number average molecular weight (Mn) of the component (A1) is preferably 1.0×10⁴ or more, more preferably 1.3×10⁴ or more, and still more preferably 1.5×10⁴ or more. From the same viewpoints, the number average molecular weight (Mn) of the component (A1) is preferably 4.0×10⁴ or less, more preferably 3.0×10⁴ or less, and still more preferably 2.0×10⁴ or less.

From the viewpoints of curing properties, curing shrinkage ratio, and modulus of elasticity, a content of the component (A1) in the resin composition is preferably 10% by mass or more, more preferably 15% by mass or more, and still more preferably 20% by mass or more relative to the total amount of the resin composition. From the same viewpoints, the content of the component (A1) in the resin composition is preferably 90% by mass or less, more preferably 55% by mass or less, still more preferably 50% by mass or less, and especially preferably 45% by mass or less relative to the total amount of the resin composition.

When the content of the component (A1) is 10% by mass or more, not only the curing properties of the resin composition may be enhanced, but also the moist heat resistance reliability of a cured material may be made favorable. Meanwhile, when the content of the component (A1) is 90% by mass or less, and preferably 55% by mass or less, not only the curing shrinkage ratio becomes favorable, but also the modulus of elasticity of a cured material does not become excessively high, and hence, such is preferred.

### <Component (A2): Monomer Having One (Meth)Acryloyl Group in a Molecule Thereof>

The monomer having one (meth)acryloyl group in a molecule thereof, that is the component (A2), is preferably liquid at ordinary temperature (25° C.); more preferably an alkyl (meth)acrylate represented by the following general formula (3) (hereinafter also referred to as “component (A2-1)”) and a compound having a (meth)acryl group and any of a hydroxyl group, an ether bond, an alicyclic group, an isobornyl group, a hindered amine, an amino group, and an amide group in a molecule thereof (hereinafter also referred to as “component (A2-2)”; and still more preferably a compound having a (meth)acryl group and any of a hydroxyl group, an ether bond, an alicyclic group, an isobornyl group, and an amide group in a molecule thereof.

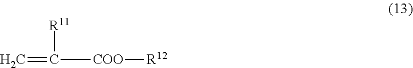

In the foregoing general formula (3), R¹¹ represents a hydrogen atom or a methyl group, and R¹² represents an alkyl group having 4 to 20 carbon atoms. From the viewpoint of more imparting flexibility, R¹² is preferably an alkyl group having 6 or more carbon atoms, and more preferably an alkyl group having 8 or more carbon atoms. From the same viewpoint, R¹² is preferably an alkyl group having 18 or less carbon atoms, and more preferably an alkyl group having 18 or less carbon atoms.

### <Component (A2-1)>

Examples of the alkyl (meth)acrylate represented by the foregoing general formula (3) include n-butyl (meth)acrylate, tert-butyl (meth)acrylate, isobutyl (meth)acrylate, n-pentyl (meth)acrylate, n-octyl (meth)acrylate, isooctyl (meth)acrylate, 2-ethylhexyl (meth)acrylate, isodecyl (meth)acrylate, n-hexyl (meth)acrylate, stearyl (meth)acrylate, lauryl (meth)acrylate, tridecyl (meth)acrylate, and the like. Of these, from the viewpoints of moist heat resistance reliability, compatibility, optical properties, workability at the time of coating, and the like, lauryl (meth)acrylate, tridecyl (meth)acrylate, stearyl (meth)acrylate, and the like are preferred.

These compounds may be used solely or in combination of two or more kinds thereof.

### <Component (A2-2)>

Examples of the compound having a (meth)acryl group and any of a hydroxyl group, an ether bond, an alicyclic group, an isobornyl group, and an amide group in a molecule thereof include (meth)acrylates having a hydroxyl group, such as 2-hydroxyethyl (meth)acrylate, 1-hydroxyethyl (meth)acrylate, 2-hydroxypropyl (meth)acrylate, 3-hydroxypropyl (meth)acrylate, 1-hydroxypropyl (meth)acrylate, 4-hydroxybutyl (meth)acrylate, 3-hydroxybutyl (meth)acrylate, 2-hydroxybutyl (meth)acrylate, and 1-hydroxybutyl (meth)acrylate; (meth)acrylamides having a hydroxyl group, such as hydroxyethyl (meth)acrylamide; mono(meth)acrylates of a polyethylene glycol such as diethylene glycol and triethylene glycol; mono(meth)acrylates of a polypropylene glycol such as dipropylene glycol and tripropylene glycol; mono(meth)acrylates of polybutylene glycol such as dibutylene glycol and tributylene glycol; (meth)acrylamide monomers such as (meth)acryloyl morpholine, dimethyl (meth)acrylamide, isopropyl (meth)acrylamide, and dimethylaminopropyl (meth)acrylamide; isobornyl (meth)acrylate; and the like.

These compounds may be used solely or in combination of two or more kinds thereof.

Of these, from the viewpoints of moist heat resistance reliability, compatibility, optical properties, workability at the time of coating, and the like, (meth)acrylates having a hydroxyl group and (meth)acrylamide monomers having a morpholino group are preferred, and 4-hydroxybutyl acrylate and acryloyl morpholine are more preferred.

From the viewpoint of obtaining a resin composition having an appropriate viscosity and the viewpoint of regulating curing shrinkage ratio and modulus of elasticity of a cured material thereof, in the case where the component (A2) is contained in the resin composition, its content is preferably 0.5% by mass or more, and more preferably 1% by mass or more relative to the total amount of the resin composition. From the same viewpoints, in the case where the component (A2) is contained, its content is preferably 10% by mass or less, more preferably 8% by mass or less, and still more preferably 6% by mass or less relative to the total amount of the resin composition.

When the content of the component (A2) is 0.5% by mass or more, a resin composition having an appropriate viscosity may be yielded, the workability at the time of coating may be made favorable, and also, the curing shrinkage ratio may be reduced. In addition, not only the curing properties of the shade part of the resulting resin composition may be made favorable, but also the transparency of a cured material may be enhanced.

When the content of the component (A2) is 10% by mass or less, excessive increases of the curing shrinkage ratio and the modulus of elasticity may be suppressed, and when used for an image display device, the generation of display unevenness may be suppressed.

In the photocurable liquid resin composition of the present invention, though the compound having a (meth)acryloyl group is compounded in an amount of preferably 10% by mass to 95% by mass relative to the total amount of the resin composition, on that occasion, it is preferred to compound the compound having a (meth)acryloyl group such that a concentration of a (meth)acryloyl group in the resin composition is 3.5×10⁻⁵ mol/g to 3.0×10⁻⁴ mol/g.

When the concentration of a (meth)acryloyl group is too low, the curing properties of the resin composition are lowered, so that there is seen a tendency that a cured material is hardly obtained; whereas in the case where the concentration of a (meth)acryloyl group is too high, the (meth)acryloyl group remains in a cured material obtained from the resin composition, so that when used for an image display device, there is a concern that the generation of color unevenness development is caused. In addition, by compounding the polymerization initiator in a rather larger amount to some extent, the residual amount of the (meth)acryloyl group in the resulting cured material may be decreased; however, there is a concern that the curing properties at a low dose or the shaded part curing properties tend to be lowered.

From the above-described viewpoints, the concentration of (meth)acryloyl group in the resin composition is preferably 3.5×10⁻⁵ mol/g or more, more preferably 4.5×10⁻⁵ mol/g or more, still more preferably 5.0×10⁻⁵ mol/g or more, and especially preferably 5.5×10⁻⁵ mol/g or more. From the same viewpoints, the concentration of (meth)acryloyl group in the resin composition is preferably 3.0×10⁻⁴ mol/g or less, more preferably 2.5×10⁻⁴ mol/g or less, still more preferably 2.0×10⁻⁴ mol/g or less, and especially preferably 1.8×10⁻⁴ mol/g or less.

It is to be noted that in the present invention, the concentration of (meth)acryloyl group in the resin composition is a value calculated according to the following calculation formula (1).

Formula (1): Concentration of (meth)acryloyl group (mol/g)=[{((the compounding amount of A₁ (g))/(the molecular weight of A₁))×(the number of (meth)acryloyl groups of A1)}+{((the compounding amount of A2 (g))/(the molecular weight of A2))×(the number of (meth)acryoyl groups of A2)}+ . . . +{((the compounding amount of Aₙ (g))/(the molecular weight of Aₙ))×(the number of (meth)acryoyl groups Aₙ)}]/{the total amount of resin composition (g)}

In the foregoing formula (1), Aᵢ, A₂, . . . Aₙ represent compounds having n kinds of (meth)acryloyl groups.

It is to be noted that in the case where the compound having a (meth)acryloyl group is a polymer, a number average molecular weight is adopted as the value of molecular weight in the formula (1).

### <Component (B): Photopolymerization Initiator>

The photopolymerization initiator as the component (B) is a kind of photopolymerization initiator that generates a radical upon irradiation with active energy rays such as ultraviolet rays, electron beams, α-rays, and β-rays, thereby promoting the curing reaction of the resin composition.

Examples of the photopolymerization initiator include aromatic ketone compounds such as benzophenone and 2,2-diethoxyacetophenone; benzoin compounds such as benzoin, methylbenzoin, and ethylbenzoin; benzoin ether compounds such as benzoin methyl ether, benzoin ethyl ether, benzoin isobutyl ether, and benzoin phenyl ether; benzyl compounds such as benzyl and benzyl dimethyl ketal; ester compounds such as β-(acridin-9-yl) (meth)acrylate; acridine compounds such as 9-phenylacridine, 9-pyridylacridine, and 1,7-diacridinoheptane; 2,4,5-triaryl imidazole dimers such as 2-(o-chlorophenyl)-4,5-diphenyl imidazole dimer and 2-(o-chlorophenyl)-4,5-di(m-methoxyphenyl) imidazole dimer; alkylphenone compounds such as 2-benzyl-2-dimethylamino-1-(4-morpholinophenyl)-1-butanone and 2-methyl-1-[4-(methylthio)phenyl]-2-morpholino-1-propane; α-hydroxyalkylphenone compounds such as 1-hydroxycyclohexyl phenyl ketone, 2-hydroxy-2-methyl-1-phenyl-propan-1-one, and 1-[4-(2-hydroxyethoxy)-phenyl]-2-hydroxy-2-methyl-1-propan-1-one; phosphine oxide compounds such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide; and the like. Of these, from the viewpoint of shaded part curing properties, phosphine oxide compounds are especially preferred.

From the viewpoint of promoting the curing reaction, a content of the component (B) is preferably 0.1% by mass or more, more preferably 0.2% by mass or more, and still more preferably 0.3% by mass or more relative to the total amount of the resin composition. Meanwhile, from the viewpoint of moist heat resistance reliability, the content of the component (B) is preferably 5.0% by mass or less, more preferably 3.0% by mass or less, still more preferably 2.5% by mass or less, and especially preferably 2.0% by mass relative to the total amount of the resin composition.

It is to be noted that in the photocurable liquid resin composition of the present invention, a thermopolymerization initiator that generates a radical by heat may be used in combination.

Examples of the thermopolymerization initiator include organic peroxides such as benzoyl peroxide, t-butyl perbenzoate, cumene hydroperoxide, diisopropylperoxy dicarbonate, di-n-propylperoxy dicarbonate, di(2-ethoxyethyl)peroxy dicarbonate, t-butylperoxy neodecanoate, t-butylperoxy pivalate, t-hexylperoxy pivalate, (3,5,5-trimethylhexanoyl)peroxide, dipropionyl peroxide, lauroyl peroxide, and diacetyl peroxide; azo compounds such as 2,2′-azobisisobutyronitrile, 2,2′-azobis(2-methylbutyronitrile), 1,1′-azobis(cyclohexane-1-carbonyl), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane]; and the like.

In the case of compounding a thermopolymerization initiator, a content of the thermopolymerization initiator is preferably 0.01% by mass to 1% by mass relative to the total amount of the resin composition.

### <Component (C): Plasticizer>

The plasticizer which is used as the component (C) in the present invention means a component which does not substantially have a (meth)acryloyl group and which is liquid at 25° C.

From the viewpoint of regulating the viscosity of the resin composition and the viewpoints of volatility and workability, a number average molecular weight of the component (C) is preferably 3.5×10² or more, and more preferably 4.0×10² or more. From the same viewpoints, the number average molecular weight of the component (C) is preferably 3.0×10⁴ or less, and more preferably 1.0×10⁴ or less.

Examples of the component (C) include liquid materials of butadiene rubber, isoprene rubber, silicon rubber, styrene butadiene rubber, chloroprene rubber, nitrile rubber, butyl rubber, ethylene propylene rubber, urethane rubber, acrylic rubber, chlorosulfonated polyethylene rubber, fluorine rubber, hydrogenated nitrile rubber, and epichlorohydrin rubber; poly-α-olefins such as polybutene; hydrogenated α-olefin oligomers such as hydrogenated polybutene; polyvinyl oligomers such as atactic polypropylene; aromatic oligomers such as biphenyl and triphenyl; hydrogenated polyene oligomers such as hydrogenated liquid polybutadiene; paraffinic oligomers such as paraffin oil and chlorinated paraffin oil; cycloparaffinic oligomers such as naphthenic oil; phthalic acid derivatives such as dimethyl phthalate, diethyl phthalate, dibutyl phthalate, di-(2-ethylhexyl) phthalate, di-n-octyl phthalate, diisobutyl phthalate, diheptyl phthalate, diphenyl phthalate, diisodecyl phthalate, ditridecyl phthalate, diundecyl phthalate, di(heptyl, nonyl, undecyl) phthalate, benzyl phthalate, butylbenzyl phthalate, dinonyl phthalate, and dicyclohexyl phthalate; isophthalic acid derivatives such as dimethyl isophthalate, di-(2-ethylhexyl) isophthalate, and diisooctyl isophthalate; tetrahydrophthalic acid derivatives such as di-(2-ethylhexyl)tetrahydrophthalate, di-n-octyl tetrahydrophthalate, and diisodecyl tetrahydrophthalate; adipic acid derivatives such as di-n-butyl adipate, di(2-ethylhexyl) adipate, diisodecyl adipate, and diisononyl adipate; azelaic acid derivatives such as di-(2-ethylhexyl) azelate, diisooctyl azelate, and di-n-hexyl azelate; sebacic acid derivatives such as di-n-butyl sebacate and di-(2-ethylhexyl) sebacate; maleic acid derivatives such as di-n-butyl maleate, dimethyl maleate, diethyl maleate, and di-(2-ethylhexyl) maleate; fumaric acid derivatives such as di-n-butyl fumarate and di-(2-ethylhexyl) fumarate; trimellitic acid derivatives such as tri-(2-ethylhexyl)trimellitate, tri-n-octyl trimellitate, triisodecyl trimellitate, triisooctyl trimellitate, tri-n-hexyl trimellitate, and triisononyl trimellitate; pyromellitic acid derivatives such as tetra-(2-ethylhexyl) pyromellitate and tetra-n-octyl pyromellitate; citric acid derivatives such as triethyl citrate, tri-n-butyl citrate, acetyl triethyl citrate, and acetyl tri-(2-ethylhexyl) citrate; itaconic acid derivatives such as monomethyl itaconate, monobutyl itaconate, dimethyl itaconate, diethyl itaconate, dibutyl itaconate, and di-(2-ethylhexyl) itaconate; oleic acid derivatives such as butyl oleate, glyceryl monooleate, and diethylene glycol monooleate; ricinoleic acid derivatives such as methyl acetyl ricinoleate, butyl acetyl ricinoleate, glyceryl monoricinoleate, and diethylene glycol monoricinoleate; stearic acid derivatives such as n-butyl stearate, glycerol monostearate, and diethylene glycol distearate; other fatty acid derivatives such as diethylene glycol monolaurate, diethylene glycol dipelargonate, and pentaerythritol fatty acid esters; phosphoric acid derivatives such as triethyl phosphate, tributyl phosphate, tri-(2-ethylhexyl)phosphate, tributoxyethyl phosphate, triphenyl phosphate, cresyl diphenyl phosphate, tricresyl phosphate, trixylenyl phosphate, and tris(chloroethyl)phosphate; glycol derivatives such as diethylene glycol dibenzoate, dipropylene glycol dibenzoate, triethylene glycol dibenzoate, triethylene glycol di-(2-ethylbutyrate), and triethylene glycol di-(2-ethylhexoate); thioglycolic acid derivatives such as dibutyl methylene bisthioglycolate; glycerin derivatives such as glycerol monoacetate, glycerol triacetate, and glycerol tributyrate; epoxy derivatives such as epoxidized soybean oil, diisodecyl epoxyhexahydrophthalate, epoxy triglyceride, epoxidized octyl oleate, and epoxidized decyl oleate; and the like.

These compounds may be used solely or in combination of two or more kinds thereof.

Of these, in the case of using an isoprene polymer containing a (meth)acryloyl group as the component (A1), from the viewpoint of volatility, the viewpoint of regulating the viscosity to an appropriate range, and the viewpoint of enhancing the workability, resistance to yellowing, compatibility, and heat resistance, butadiene rubber, isoprene rubber, poly-α-olefins, hydrogenated α-olefin oligomers, and di-(2-ethylhexyl) sebacate are preferred; and butadiene rubber, poly-α-olefins, and di-(2-ethylhexyl) sebacate are more preferred.

From the viewpoint of regulating the elastic force of a cured material to an appropriate range, a content of the component (C) is preferably 10% by mass or more, more preferably 30% by mass or more, still more preferably 50% by mass or more, and especially preferably 60% by mass or more relative to the total amount of the resin composition. From the same viewpoint, the content of the component (C) is preferably 90% by mass or less, more preferably 85% by mass or less, still more preferably 80% by mass or less, and especially preferably 77% by mass or less relative to the total amount of the resin composition.

### <Component (D): Antioxidant>

Examples of the so-called antioxidant include various compounds such as hindered phenol-based compounds, amine-based compounds, phosphorus-based compounds, sulfur-based compounds, hydrazine-based compounds, and amide-based compounds; however, of these compounds, especially from the viewpoint that the bleedout can be prevented, a hindered phenol-based compound is preferred as the antioxidant which is used as the component (D) in the present invention, and furthermore, taking into account the viewpoint of suppressing yellowing, it is preferred to use a hindered phenol-based compound in combination with a sulfur-based compound. Of the sulfur-based compounds, in particular, a compound having a thioether structure is more preferred.

By using (D1) a compound having a hindered phenol structure in a molecule thereof as the component (D), the bleedout can be suppressed. Furthermore, for the purpose of not only suppressing the bleedout but also suppressing the yellowing, a hindered phenol-based compound having a hindered phenol structure and a thioether structure in a molecule thereof can be used solely. In addition, by separately compounding a compound having a thioether structure in addition to the hindered phenol-based compound, these compounds can also be used in combination. The component (D) is hereunder described.

### <Component (D1): Compound Having a Hindered Phenol Structure in a Molecule Thereof>

It is preferred to use a compound represented by the following general formula (a) for the compound having a hindered phenol structure in a molecule thereof, that is the component (D1).

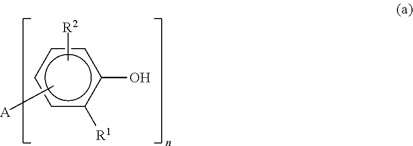

In the general formula (a), R¹ represents a tert-butyl group or —CH₂—S—R³; R² represents an alkyl group having 1 to 5 carbon atoms or —CH₂—S—R³; and a plurality of R²s may be each present as an independent substituent. In addition, n represents an integer of 1 to 4, and A represents an n-valent organic group. In addition, R³ represents an alkyl group having 1 to 20 carbon atoms.

Examples of the compound having a hindered phenol structure, that is the component (D1), include pentaerythritol tetrakis[3-(3,5-di-tert-butyl-hydroxyphenyl)propionate] (IRGANOX 1010, manufactured by BASF Japan Ltd.), thiodiethylene bis[3-(3,5-di-tert-butyl-4-hydroxyphenyl)propionate] (IRGANOX 1035, manufactured by BASF Japan Ltd.), octadecyl-3-(3,5-di-tert-butyl-4-hydroxyphenyl)propionate (IRGANOX 1076, manufactured by BASF Japan Ltd.), N,N′-hexane-1,6-diyl bis[3-(3,5-di-tert-butyl-4-hydroxyphenyl)propionamide (IRGANOX 1098, manufactured by BASF Japan Ltd.), benzenepropanoic acid, 3,5-bis(1,1-dimethylethyl)-4-hydroxy, C7-C9 side chain alkyl ester (IRGANOX 1135, manufactured by BASF Japan Ltd.), 2,4-dimethyl-6-(1-methylpentadecyl)phenol (IRGANOX 1141, manufactured by BASF Japan Ltd.), diethyl[{3,5-bis(1,1-dimethylethyl)-4-hydroxyphenyl}methyl]phosphonate (IRGANOX 1222, manufactured by BASF Japan Ltd.), 3,3′,3″,5,5′,5″-hexa-tert-butyl-a,a′,a″-(mesitylene-2,4,6-triyl)tri-p-cresol (IRGANOX 1330, manufactured by BASF Japan Ltd.), a mixture of calcium diethyl bis[[[3,5-bis(1,1-dimethylethyl)-4-hydroxyphenyl]methyl]phosphonate] and polyethylene wax (IRGANOX 1425WL, manufactured by BASF Japan Ltd.), 4,6-bis(octylthiomethyl)-o-cresol (IRGANOX 1520L, manufactured by BASF Japan Ltd.), ethylene bis(oxyethylene)bis[3-(tert-butyl-4-hydroxy-m-tolyl)propionate] (IRGANOX 245, manufactured by BASF Japan Ltd.), 1,6-hexanediol-bis[3(3,5-di-t-butyl-4-hydroxyphenyl)propionate] (IRGANOX 259, manufactured by BASF Japan Ltd.), 1,3,5-tris(3,5-di-tert-butyl-4-hydroxybenzyl)isocyanuric acid (IRGANOX 3114, manufactured by BASF Japan Ltd.), 1,3,5-tris[(4-tert-butyl-3-hydroxy-2,6-xylyl)methyl]-1,3,5-triazine-2,4,6(1H,3H,5H)-trione (IRGANOX 3790, manufactured by BASF Japan Ltd.), a reaction product between N-phenylbenzeneamine and 2,4,4-trimethylpentene (IRGANOX 5057, manufactured by BASF Japan Ltd.), 1,3,5-tris(3,5-di-tert-butyl-4-hydroxybenzyl)isocyanuric acid (ADEKA STAB AO-20, manufactured by Adeka Corporation), 1,1,3-tris(2-methyl-4-hydroxy-5-tert-butylphenyl)butane (ADEKA STAB AO-30, manufactured by Adeka Corporation), 4,4′-butylidene bis(6-tert-butyl-3-methylphenol) (ADEKA STAB AO-40, manufactured by Adeka Corporation), n-octadecyl 3-(4′-hydroxy-3′,5′-di-tert-butylphenyl)propionate (ADEKA STAB AO-50, manufactured by Adeka Corporation), pentaerythritol tetrakis[3-(3′,5′-di-tert-butyl-4′-hydroxyphenyl)propionate] (ADEKA STAB AO-60, manufactured by Adeka Corporation), triethylene glycol bis[3-(3-t-butyl-4-hydroxy-5-methylphenyl)propionate (ADEKA STAB AO-70, manufactured by Adeka Corporation), 3,9-bis[1,1-dimethyl-2-[β-(3-t-butyl-4-hydroxy-5-methylphenylpropionyloxy]ethyl]2,4,8,10-tetraoxaspiro[5,5]-undecane (ADEKA STAB AO-80, manufactured by Adeka Corporation), 1,3,5-trimethyl-2,4,6-tris(3,5-di-tert-butyl-4-hydroxybenzyl)benzene (ADEKA STAB AO-330, manufactured by Adeka Corporation), 2,2-oxamidobis-[ethyl-3-(3,5-di-t-butyl-4-hydroxyphenyl]propionate (NAUGARD XL-1, manufactured by Crompton-Uniroyal Chemical), 1,1,3-tris{2-methyl-4-[3-(3,5-di-tert-butyl-4-hydroxyphenyl)propionyloxy]-5-tert-butylphenyl}butane (GSY-242, manufactured by API Corporation), and the like. Of these, from the viewpoint that the bleedout can be suppressed, pentaerythritol tetrakis[3-(3,5-di-t-butyl-4-hydroxyphenyl)propionate] and 4,6-bis(octylthiomethyl)-o-cresol are preferred, and from the viewpoint that both the bleedout and the yellowing can be suppressed, 4,6-bis(octylthiomethyl)-o-cresol having a thioether structure in a molecule thereof is especially preferred.

### <Component (D2): Compound Having a Thioether Structure in a Molecule Thereof>

It is preferred to use a compound represented by the following general formula (b) for the compound having a thioether structure in a molecule thereof, that is the component (D2).

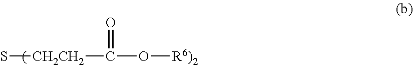

In the general formula (b), R⁶ represents an alkyl group having 1 to 20 carbon atoms.

Examples of the compound having a thioether structure in a molecule thereof, that is the component (D2), include didodecyl thiodipropionate (SEENOX DL, manufactured by Shipro Kasei Kaisha, Ltd., IRGANOX PS 800 FL, manufactured by BASF Japan Ltd., and SUMILIZER TPL-R, manufactured by Sumitomo Chemical Co., Ltd.), ditridecyl thiodipropionate (AO-503, manufactured by ADEKA Corporation), ditetradecyl thiodipropionate (SUMILIZER TPM, manufactured by Sumitomo Chemical Co., Ltd.), and distearyl thiodipropionate (SUMILIZER TPD, manufactured by Sumitomo Chemical Co., Ltd.).

From the viewpoint that the bleedout can be more suppressed, a content of the component (D) is preferably 0.5% by mass or more, more preferably 0.6% by mass or more, and still more preferably 0.7% by mass or more relative to the total amount of the resin composition. From the same viewpoint, the content of the component (D) is preferably 3.0% by mass or less, more preferably 2.7% by mass or less, and still more preferably 2.5% by mass or less relative to the total amount of the resin composition.

In addition, in the case of using the component (D1) and the component (D2) in combination, from the viewpoint that the bleedout can be more suppressed, a ratio of the component (D1) and the component (D2) is preferably 0.25 or more, more preferably 0.33 or more, and still more preferably 0.5 or more in terms of a (D1)/(D2) ratio. From the same viewpoint, the (D1)/(D2) ratio is preferably 4 or less, more preferably 3 or less, and still more preferably 2 or less.

### <Other Additives>

In the photocurable liquid resin composition of the present invention, other additives may be further compounded within a range where the effects of the present invention are not hindered.

Examples of other additives include stabilizers such as triphenyl phosphite; thiol compounds such as 1,4-bis(3-mercaptobutylyloxy)butane, 1,3,5-tris(3-mercaptobutyloxyethyl)-1,3,5-triazine-2,4,6(1H,3H,5H)-trione, and pentaerythritol tetrakis(3-mercaptobutyrate); and the like.

From the viewpoints of moist heat resistance reliability and suppression of the generation of air bubbles in a cured material, it is preferred that the photocurable liquid resin composition of the present invention does not substantially contain an organic solvent (resolvent).

Here, the terms “does not substantially contain an organic solvent” mean that the organic solvent is not intentionally added, and a trace amount of the organic solvent may exist to an extent that the properties of the photocurable liquid resin composition of the present invention after photocuring are not conspicuously lowered.

Specifically, a content of the organic solvent in the resin composition may be 1.0×10³ ppm or less, preferably 5.0×10² ppm or less, and still more preferably 1.0×10² ppm or less relative to the total amount of the resin composition, and it is even still more preferred that the organic solvent is not contained at all.

It is to be noted that in the present invention, the “organic solvent” means an organic compound not having a (meth)acryloyl group, which is liquid at 25° C. and has a boiling point of 250° C. or lower at atmospheric pressure.

### [Physical Properties of Resin Composition]

From the viewpoint of workability, a viscosity at 25° C. of the photocurable liquid resin composition of the present invention is preferably 5.0×10² mPa·s or more, more preferably 1.0×10³ mPa·s or more, and still more preferably 2.0×10³ mPa·s or more. From the same viewpoint, the viscosity at 25° C. of the photocurable liquid resin composition of the present invention is preferably 5.0×10³ mPa·s or less, more preferably 4.0×10³ mPa·s or less, and still more preferably 3.5×10³ mPa·s or less.

It is to be noted that the viscosity at 25° C. as referred to herein is a value measured in conformity with JIS Z8803, and specifically, it means a value measured by a B-type viscometer (BL2, manufactured by Toki Sangyo Co., Ltd.).

In addition, the calibration of the viscometer can be performed in conformity with JIS Z8809-JS14000.

It is to be noted that in the photocurable liquid resin composition of the present invention, even when a dose of active energy rays such as ultraviolet rays, electron beams, α-rays, and β-rays is low as 50 mJ/cm², the curing reaction may be thoroughly advanced.

### [Physical Properties of Cured Material of Resin Composition]

When used as a structural member of the image display device, from the viewpoint of more highly suppressing a warp of a substrate of a protective panel, an image display unit, or the like, a curing shrinkage ratio of the photocurable liquid resin composition of the present invention is preferably less than 3.0%, and more preferably less than 1.5%. In the case where the curing shrinkage ratio is less than 3.0%, the warp of the substrate, which may also possibly cause the generation of display unevenness, may be thoroughly suppressed.

When used as a structural member of the image display device, from the viewpoints of suppressing local stress addition to an image display unit or the like and suppressing the generation of display unevenness, a modulus of elasticity of a cured material of the photocurable liquid resin composition of the present invention is preferably 8.0×10⁴ Pa or less, more preferably 2.0×10⁴ Pa or less, and still more preferably 1.5×10⁴ Pa or less. When the modulus of elasticity is 8.0×10⁴ Pa or less, the local stress addition to the image display unit, which may also possibly cause the generation of display unevenness, may be suppressed.

In addition, as for the modulus of elasticity of a cured material of the photocurable liquid resin composition of the present invention, so long as when heated, the liquid material does not separate or drip down from the cured material, a lower limit of the modulus of elasticity is not limited; however, it is preferably 1.0×10³ Pa or more.

It is to be noted that in the present invention, the modulus of elasticity of a cured material of the resin composition is a value of a modulus in tension obtained by measuring a cured material having a film thickness t of 1 mm and a width of 10 mm at a chuck-to-chuck distance of 25 mm at 25° C. by using an autograph (trade name, “EZ Test”, manufactured by Shimadzu Corporation).

### [Image Display Device]

A liquid crystal display device that is an example of an image display device capable of being manufactured using the photocurable liquid resin composition of the present invention is hereunder described.

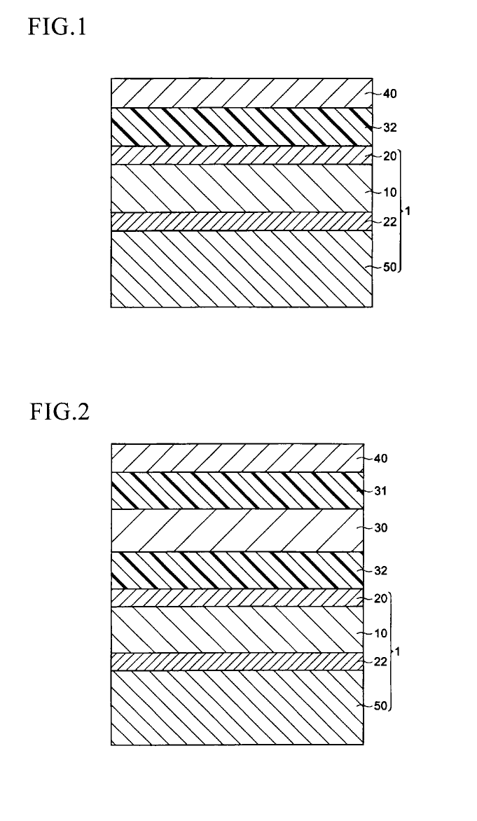

FIG. 1 is a side cross-sectional view schematically showing an embodiment of a liquid crystal display device that is an example of the image display device of the present invention. The liquid crystal display device shown in FIG. 1 is configured of an image display unit 1 in which a backlight system 50, a polarizing plate 22, a liquid crystal display cell 10, and a polarizing plate 20 are laminated in this order; a transparent resin layer 32 provided on the upper surface of the polarizing plate 20 working as the viewing side of the liquid crystal display device; and a transparent protective substrate (protective panel) 40 provided on the surface thereof. It is to be noted that the transparent resin layer 32 is constituted of a cured material of the photocurable liquid resin composition of the present invention.

FIG. 2 is a side cross-sectional view schematically showing a liquid crystal display device having a touch panel mounted thereon, which is an embodiment of a liquid crystal display device that is an example of the image display device of the present invention. The liquid crystal display device shown in FIG. 2 is configured of an image display unit 1 in which a backlight system 50, a polarizing plate 22, a liquid crystal display cell 10, and a polarizing plate 20 are laminated in this order; a transparent resin layer 32 provided on the upper surface of the polarizing plate 20 working as the viewing side of the liquid crystal display device; a touch panel 30 provided on the upper surface of the transparent resin layer 32; a transparent resin layer 31 provided on the upper surface of the touch panel 30; and a transparent protective substrate 40 provided on the surface thereof.

It is to be noted that in the liquid crystal display device shown in FIG. 2, though the transparent resin layer intervenes both between the image display unit 1 and the touch panel 30 and between the touch panel 30 and the transparent protective substrate 40, the transparent resin layer has only to intervene in at least either one of them. In addition, in the case where the touch panel is of an on-cell type, the touch panel and the liquid crystal display cell are integrated with each other. Specific examples thereof include one in which the liquid crystal display cell 10 of the liquid crystal display device of FIG. 1 is replaced by one of an on-cell type.

According to the liquid crystal display devices shown in FIGS. 1 and 2, since a cured material of the photocurable liquid resin composition of the present invention is provided as the transparent resin layer 31 or 32, these liquid crystal display devices have impact resistance, and an image which is free from ghost reflections, is clear, and is high in contrast is obtained.

For the liquid crystal display cell 10, those constituted of a liquid crystal material which is well-known in the subject technical field can be used. In addition, though liquid crystal display cells are classified into a TN (twisted nematic) mode, an STN (super-twisted nematic) mode, a VA (vertical alignment) mode, an IPS (in-place-switching) mode, and the like depending upon the control method of the liquid crystal material, the liquid crystal display cell in the present invention may be a liquid crystal display cell adopting any control method.

As for the polarizing plates 20 and 22, a polarizing plate which is general in the subject technical field can be used.

The surface of the polarizing plate may be subjected to a treatment such as anti-reflection, antifouling, and hard coating. Such a surface treatment may be applied to one surface or both surfaces of the polarizing plate.

In addition, as for the touch panel 30, a touch panel which is generally used in the subject technical field can be used.

The transparent layer 31 or 32 may be formed in a thickness of, for example, 0.02 mm to 3 mm. In particular, the photocurable liquid resin composition of the present invention is easily formed into a thick film and is suitable in the case of forming the transparent resin layer 31 or 32 of 0.1 mm or more.

As for the transparent protective substrate 40, a general optical transparent substrate can be used.

Examples of the transparent protective substrate include a plate of an inorganic material such as a glass plate and a quartz plate, a resin plate such as an acrylic plate and a polycarbonate plate, and a resin sheet such as a thick polyester sheet. Of these, in the case where a high surface hardness is required, a glass plate and an acrylic plate are preferred, and a glass plate is more preferred.

It is to be noted that the surface of the transparent protective substrate 40 may be subjected to a treatment such as anti-reflection, antifouling, and hard coating. Such a surface treatment may be applied to one surface or both surfaces of the transparent protective substrate. In addition, the transparent protective substrate can also be used in combination of plural sheets of substrates.

Though the backlight system 50 is not particularly limited with respect to its configuration, it is typically configured of a reflection means such as a reflection plate and an illumination means such as a lamp. As for these reflection means and illumination means, known means and configurations which are applied in usual image display devices can be applied.

### [Manufacturing Method of Image Display Device]

The image display devices using the photocurable liquid resin composition of the present invention as shown in FIGS. 1 and 2 can be manufactured by the following method.

First of all, the image display device provided with an image display unit and a protective panel as shown in FIG. 1 can be manufactured through a step of allowing the photocurable liquid resin composition of the present invention to intervene between the image display unit and the protective panel (hereinafter also referred to as “step (1a)”); and a step of performing irradiation with light from the side of the protective panel surface, to cure the resin composition, thereby forming a transparent resin layer (hereinafter also referred to as “step (2a)”).

In addition, the image display device provided with an image display unit, a touch panel, and a protective panel as shown in FIG. 2 can be manufactured through a step of allowing the photocurable liquid resin composition of the present invention to intervene between the image display unit and the touch panel, and/or between the touch panel and the protective panel (hereinafter also referred to as “step (1b)”); and a step of performing irradiation with light from the side of the protective panel surface, to cure the resin composition, thereby forming a transparent resin layer (hereinafter also referred to as “step (2b)”).

Here, in the case of manufacturing a liquid crystal display device using a conventional resin composition, sufficient light does not reach the photocurable resin composition filled within a space in a back side portion of a shaded part to become a hindrance to curing, so that curing of the photocurable resin composition in the surroundings of the shaded part does not sufficiently proceed, and the quality of the image display device is largely impaired, resulting in a lowering of the reliability.

However, the photocurable liquid resin composition of the present invention has excellent shaded part curing properties, and therefore, the resin composition filled within the above-described space can also be cured, and even in the case where a dose of active energy rays such as ultraviolet rays is low, it is possible to thoroughly cure the resin composition. For that reason, according to the manufacturing method of an image display device using the photocurable liquid resin composition of the present invention, an image display device having an excellent quality can be manufactured with good productivity.

In the steps (1a) and (1b), examples of the method of allowing the photocurable liquid resin composition of the present invention to intervene between the image display unit and the protective panel, or the like include a method in which the subject resin composition is coated on the image display unit or the protective panel by using a dispenser, followed by sticking in vacuo (under reduced pressure) or at atmospheric pressure; a method in which the subject resin composition is cast between the image display unit and the protective panel disposed at a fixed interval; and the like.

It is to be noted that at the time of casting the photocurable liquid resin composition of the present invention, a dam may be formed in the surroundings of the image display unit and the protective panel.

The irradiation with light in the steps (2a) and (2b) is performed by irradiation with active energy rays such as ultraviolet rays, electron beams, α-rays, and β-rays, and for example, it can be performed by using an ultraviolet ray irradiation apparatus. It is to be noted that in the photocurable liquid resin composition of the present invention, for example, even when the dose is low as 50 mJ/cm², the curing reaction may be thoroughly advanced. For that reason, so far as the dose is 50 mJ/cm² or more, it is possible to thoroughly advance the curing reaction to obtain a cured material. It is to be noted that an upper limit value of the dose is preferably 5.0×10³ mJ/cm² or less.

It is to be noted that the dose as referred to herein means a value obtained by multiplying an illuminance measured by an ultraviolet ray irradiation apparatus (trade name, “UV-MO2” (light receptor: UV-36), manufactured by Oak Manufacturing Co., Ltd.) etc. by an irradiation time (sec).

Examples of a light source for irradiation with ultraviolet rays include a low-pressure mercury vapor lamp, a medium-pressure mercury vapor lamp, a high-pressure mercury vapor lamp, a metal halide lamp, an LED lamp, and the like. Of these, a high-pressure mercury vapor lamp and a metal halide lamp are preferred.

It is to be noted that at the time of irradiation with light, irradiation from the protective panel side and irradiation from the side surface may be used in combination. In addition, curing can also be promoted by means of heating of the laminate containing the curable resin composition or other means simultaneously with irradiation with light.

In the light of the above, while the liquid crystal display device that is one of image display devices which can be manufactured by using the photocurable liquid resin composition of the present invention has been described, the image display device which can be manufactured by using the photocurable liquid resin composition of the present invention is not limited thereto. For example, it is also possible to apply the photocurable liquid resin composition of the present invention to a plasma display panel (PDP), a cathode ray tube (CRT), a field emission display (FED), an organic EL display, a 3D display, an electronic paper, or the like.

In particular, it is more suitable to fabricate a transparent resin layer by using the photocurable liquid resin composition of the present invention in an image display device having a size of 10 inches or more.

### EXAMPLES

The present invention is more specifically described below with reference to the following Examples, but it should not be construed that the present invention is limited to the following Examples.

In addition, a number average molecular weight (Mn) of a polymer having a (meth)acyloyl group as used in the following Examples is a value measured on the basis of the following method.

### [Measurement Method of Number Average Molecular Weight (Mn)]

The number average molecular weight was determined by adopting gel permeation chromatography (GPC) with tetrahydrofuran (THF) as a solvent and preparing a calibration curve using polystyrene as a standard substance. In preparing the calibration curve, a five-sample set (trade name, “PStQuick MP-H, PStQuick B”, manufactured by Tosoh Corporation) was used as the standard polystyrene.

Apparatus: High-performance GPC apparatus, HCL-8320GPC (detector: differential refractometer or UV) (trade name, manufactured by Tosoh Corporation)
Solvent used: Tetrahydrofuran (THF)
Column: Column TSKgel SuperMultipore HZ-H (trade name, manufactured by Tosoh Corporation)
Column size: Column length=15 cm, column inner diameter=4.6 mm
Measurement temperature: 40° C.
Flow rate: 0.35 mL/min
Sample concentration: 10 mg/5 mL-THF
Injection amount: 20 μL

### Examples 1 to 9 and Comparative Examples 1 to 4

The components (A) to (D) were compounded in a compounding ratio shown in Table 1 and mixed with stirring by heating at 90° C. for 30 minutes, thereby preparing resin compositions of Examples 1 to 9 and Comparative Examples 1 to 4. It is to be noted that in Table 1, the units of the numerical values with respect to the components (A) to (D) are a part by mass.

It is to be noted that among the respective components shown in Table 1, details of the component (A), the component (C), and each of the components of (D1) and (D2) as the component (D) are as follows.

### Component (A):

Isoprene methacrylate: trade name, “UC-102”, manufactured by Kuraray Co., Ltd. This has the structure represented by the foregoing general formula (2), wherein R¹ is a methyl group, and n is 2 (the number of methacryloyl groups=2), and has an Mn of 1.7×10⁴.
Acryloyl morpholine: the number of acryloyl groups=1, molecular weight=141.17.
4-Hydroxybutyl acrylate: the number of acryloyl groups=1, molecular weight=144.2.
Lauryl acrylate: the number of acryloyl groups=1, molecular weight=240.4.

### Component (C):

Butadiene rubber: trade name, “LBR-307”, manufactured by Kuraray Co., Ltd. Number average molecular weight (Mn)=8.0×10³. Poly(1-decene): trade name, “DURASYN 170”, manufactured by INEOS Oligomers Japan. Poly-α-olefin, number average molecular weight (Mn)=6.9×10².

### Component (D):

### Component (D1):

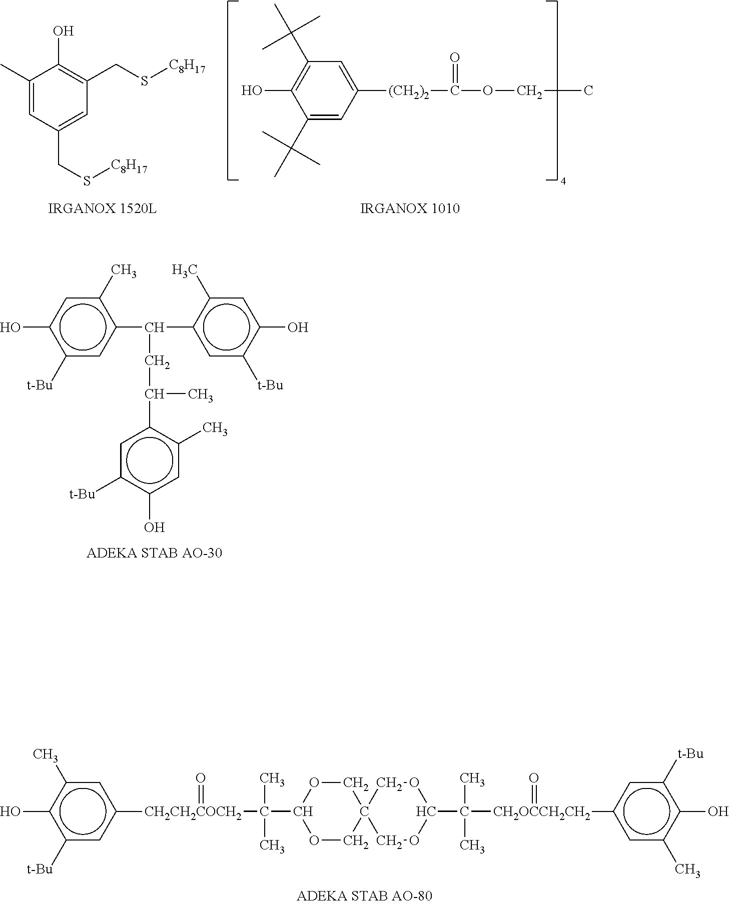

### Component (D2):

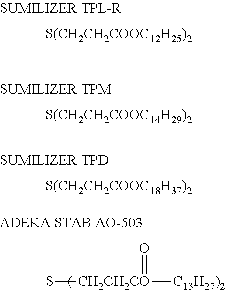

In addition, the concentration of (meth)acryloyl group in the resin composition was calculated according to the foregoing calculation formula (1).

It is to be noted that as for the numerical values shown in Table 1, the compounding amount of each component is expressed as a ratio in terms of “parts by mass”; however, in calculating the concentration of (meth)acryloyl group, the calculation is made while considering the unit of the numerical value shown in Table 1 as “g”.

For example, the concentration of (meth)acryloyl group in the resin composition of Example 1 is [{((compounding amount of isoprene methacrylate)/(molecular weight of isoprene methacrylate))×(the number of average methacryloyl groups of isoprene methacrylate)}+{((compounding amount of acryloyl morpholine)/(molecular weight of acryloyl morpholine))×(the number of acryloyl group of acryloyl morpholine)}]/(total amount of resin composition) [{(28.00/17000)×2}+{(1.00/141.17)×1}]/101.4=1.0×10⁻⁴ (mol/g).

As for the resin composition and its cured material obtained in each of the Examples and Comparative Examples, the following tests were performed, and the respective properties were evaluated. The results are shown in Table 1.

### (Viscosity of Resin Composition)

A viscosity at 25° C. (unit: mPa·s) of the resin composition obtained in each of the Examples and Comparative Examples was measured using a B-type viscometer (BL-2, manufactured by Toki Sangyo Co., Ltd.).

(Bleedout)

The resin composition prepared in each of the Examples and Comparative Examples was dropped on a 2-inch glass substrate, and another one sheet of glass substrate was stuck thereonto via a spacer of 5.0×10² μm. Then, the resultant was irradiated with ultraviolet rays at a dose of 2.0×10³ mJ/cm² from the side of one of the glass substrates by using the above-described ultraviolet ray irradiation apparatus, to cure the resin composition, thereby fabricating a test piece. This test piece was placed vertically while turning one corner thereof downward and put into a test tank at 95° C., and after elapsing several thousand hours, the bleedout was evaluated through visual inspection and evaluated according to the following criteria.

A: After the lapse of 2,500 hours, the shape of the corner of the downside is kept.

B: After the lapse of 2,000 hours, the liquid material oozes out from the corner.

F: After the lapse of 1,000 hours, the liquid material oozes out from the corner.

### (Resistance to Yellowing)

The resin composition prepared in each of the Examples and Comparative Examples was dropped on a 2-inch glass substrate, and another one sheet of glass substrate was stuck thereonto via a spacer of 5.0×10² μm. Then, the resultant was irradiated with ultraviolet rays at a dose of 2.0×10³ mJ/cm² from the side of one of the glass substrates by using the above-described ultraviolet ray irradiation apparatus, to cure the resin composition, thereby fabricating a test piece. This test piece was placed vertically while turning one corner thereof downward and put into a test tank at 95° C. for 1,000 hours, the glass surface was visually inspected with transmitted light, and the presence or absence of the generation of yellowing was evaluated according to the following criteria.

A: No change in the appearance of the test piece is observed.

F: Yellowing can be confirmed with the naked eyes.

### (Modulus of Elasticity of Cured Material)

On a polyethylene terephthalate (hereinafter also referred to as “PET”) film, a surface of which had been subjected to a release treatment, the resin composition prepared in each of the Examples and Comparative Examples was dropped, and another one sheet of PET film was stuck thereonto such that a film thickness after curing of the resin composition was 1 mm. Then, the resultant was irradiated with ultraviolet rays at a dose of 2.0×10³ mJ/cm² from the side of one of the PET films by using the above-described ultraviolet ray irradiation apparatus, to cure the resin composition, thereby fabricating a cured material.

Subsequently, the PET films were separated off; the cured material was aliquoted in a width of 10 mm, to prepare a test piece, which was then measured for a modulus intension at a chuck-to-chuck distance of 25 mm at 25° C. by using an autograph (trade name, “EZ Test”, manufactured by Shimadzu Corporation); and the measured modulus in tension was defined as a modulus of elasticity (unit: Pa) of the cured material.

### (Evaluation of Curing Properties at Low Dose)

On a PET film, a surface of which had been subjected to a release treatment, the resin composition prepared in each of the Examples and Comparative Examples was dropped, and another one sheet of PET film was stuck thereonto such that a film thickness after curing of the resin composition was 2.0×10² μm. Then, the resultant was irradiated with ultraviolet rays at a dose of 50 mJ/cm² from the side of one of the PET films by using the above-described ultraviolet ray irradiation apparatus, to cure the resin composition, thereby fabricating a cured material. After the irradiation, the PET films were separated off, and at the time of touching the cured material with fingers, the presence or absence of separation of the cured material was confirmed through visual inspection and evaluated according to the following criteria.

A: The cured material is not separated.

F: The cured material is separated because of the presence of a liquid portion, and thus, curing is insufficient.

### (Evaluation of Curing Properties of Shaded Part)

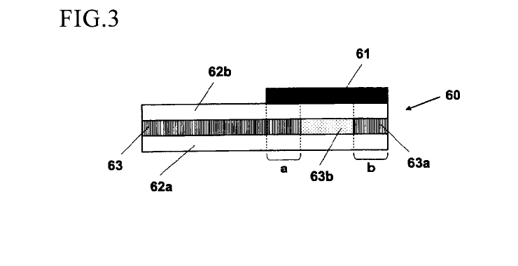

FIG. 3 is a side cross-sectional view of a test sample used for evaluating shaded part curing properties. Explanation is hereunder made while properly referring to FIG. 3.

On a PET film 62a (50 mm×50 mm×100 μm), a surface of which had been subjected to a release treatment, a resin composition 63 prepared in each of the Examples and Comparative Examples was dropped, and another one sheet of PET film 62b was stuck thereonto such that a film thickness after curing of the resin composition was 200 μm. Then, a light shielding mask 61 having a size of 50 mm×20 mm×250 μm and having an OD value of 4.0 was stuck onto an upper part of the PET film 62b, thereby fabricating a test sample 60.

Subsequently, the test sample 60 was placed on an aluminum vat and irradiated with ultraviolet rays at a dose of 2.0×10³ mJ/cm² from the side of the PET film 62b on which the light shielding mask 61 was present by using the above-described ultraviolet ray irradiation apparatus, thereby curing the resin composition. After the irradiation, the PET films were separated off, a boundary line between a cured portion 63a of the resin composition and an uncured portion 63b of the resin composition under the light shielding mask, and a distance between edges of the light shielding mask were measured through visual inspection.

As shown in FIG. 3, distances a and b from the both edges of the light shielding mask to the boundary line between the cured portion 63a and the uncured portion 63b were measured, respectively, and a value of (a+b) was defined as a shaded part curing distance (unit: mm). The larger the shaded part curing distance, the more excellent the shaded part curing properties are.

### (Moist Heat Resistance Reliability)

The resin composition prepared in each of the Examples and Comparative Examples was dropped on a 2-inch glass substrate, and another one sheet of glass substrate was stuck thereonto via a spacer of 5.0×10² μm. Then, the resultant was irradiated with ultraviolet rays at a dose of 2.0×10³ mJ/cm² from the side of one of the glass substrates by using the above-described ultraviolet ray irradiation apparatus, to cure the resin composition, thereby fabricating a test piece. This test piece was put in a test tank at 60° C. and 75% RH (relative humidity) for 500 hours, and the presence or absence of the generation of separation, air bubbles, yellowing, or drip was evaluated through visual inspection and evaluated according to the following criteria.

A: No change.

F: The generation of separation, air bubbles, yellowing, or drip was confirmed.

### (Curing Shrinkage Ratio)

The curing shrinkage ratio was calculated according to the following calculation formula.

Curing shrinkage ratio (%)=[{1/(specific gravity of liquid)}-{1/(specific gravity of cured material)}]/{1/(specific gravity of liquid)}

Here, the specific gravity of liquid and the specific gravity of cured material were determined as follows.

### (Specific Gravity of Liquid)

The specific gravity of liquid was measured using a Hubbard specific gravity bottle in conformity with JIS K0061.

### (Specific Gravity of Cured Material)

On a PET film, a surface of which had been subjected to a release treatment, the resin composition prepared in each of the Examples and Comparative Examples was dropped, and another one sheet of PET film was stuck thereonto such that a film thickness after curing of the resin composition was 1 mm. Then, the resultant was irradiated with ultraviolet rays at a dose of 2.0×10³ mJ/cm² from the side of one of the PET films by using the above-described ultraviolet ray irradiation apparatus, to cure the resin composition, thereby fabricating a cured material.

Subsequently, the PET films were separated off, the cured material was aliquoted in a size of 10 mm×10 mm, to prepare a test piece, which was then measured for a specific gravity at 25° C. by using a specific gravity meter (trade name, “SD-200L”, manufactured by Alfa Mirage Co., Ltd.), and the measured specific gravity was defined as the specific gravity of cured material.

TABLE 1

| | | | Example | | | | | | |
|---|---|---|---|---|---|---|---|---|---|
| Item | | | 1 | 2 | 3 | 4 | 5 | 6 | 7 |
| Component | Isoprene methacrylate | | 28.00 | 28.00 | 45.00 | 45.00 | 45.00 | 45.00 | 45.00 |
| (A) | Acryloyl morpholine | | 1.00 | — | 1.00 | 1.00 | 1.00 | 1.00 | 1.00 |
| | Lauryl acrylate | | — | — | — | — | — | — | — |
| | 4-Hydroxybutyl acrylate | | — | 1.00 | — | — | — | — | — |
| Component | 2,4,6-Trimethylbenzoyl- | | 0.40 | 0.40 | 0.40 | 0.40 | — | 0.40 | 0.40 |
| (B) | diphenylphosphine oxide | | | | | | | | |
| | Bis(2,4,6-trimethylbenzoyl)- | | — | — | — | — | 0.40 | — | — |
| | phenylphosphine oxide | | | | | | | | |
| Component | Butadiene rubber | | 51.92 | 51.92 | 4.00 | 4.00 | 4.00 | 4.00 | 4.00 |
| (C) | Poly(1-decene) | | 19.08 | 19.08 | 50.00 | 50.00 | 50.00 | 50.00 | 50.00 |
| Component | D1 | IRGANOX 1010 | — | — | — | 1.00 | 1.00 | 1.00 | 1.00 |
| (D) | | ADEKA STAB AO-30 | — | 1.00 | — | — | — | — | — |
| | | ADEKA STAB AO-80 | — | — | 1.00 | — | — | — | — |
| | | IRGANOX 1520L | 1.00 | — | — | — | — | — | — |
| | D2 | SUMILIZER^{(R)} TPL-R | — | — | — | — | 1.00 | — | — |
| | | SUMILIZER^{(R)} TPM | — | 1.00 | 1.00 | — | — | 1.00 | — |
| | | SUMILIZER^{(R)} TPD | — | — | — | — | — | — | 1.00 |
| | | ADEKA STAB AO-503 | — | — | — | 1.00 | — | — | — |

| | | | | | | | | |
|---|---|---|---|---|---|---|---|---|
| Properties | Concentration of | 1.0 | 1.0 | 1.2 | 1.2 | 1.2 | 1.2 | 1.2 |
| | (Meth)acryloyl group | | | | | | | |
| | (10⁻⁴ mol/g) | | | | | | | |
| | Viscosity (mPa · s) | 3100 | 3100 | 3150 | 3050 | 3100 | 3100 | 3150 |
| | Bleedout | A | A | A | A | A | A | A |
| | Resistance to yellowing | A | A | A | A | A | A | A |
| | Modulus of elasticity of | 12000 | 11000 | 76000 | 76000 | 76000 | 76000 | 76000 |
| | cured material (Pa) | | | | | | | |
| | Curing properties at low dose | A | A | A | A | A | A | A |
| | Shaded part curing (mm) | 9.0 | 9.5 | 9.0 | 9.5 | 9.5 | 9.5 | 9.0 |
| | Moist heat resistance | A | A | A | A | A | A | A |
| | reliability | | | | | | | |
| | Curing shrinkage ratio (%) | 0.7 | 0.7 | 0.8 | 0.8 | 0.8 | 0.8 | 0.8 |

| | | | Example | | Comparative Example | | | |
|---|---|---|---|---|---|---|---|---|
| Item | | | 8 | 9 | 1 | 2 | 3 | 4 |
| Component | Isoprene methacrylate | | 24.00 | 45.00 | 28.00 | 28.00 | 45.00 | 45.00 |
| (A) | Acryloyl morpholine | | 1.00 | 1.00 | 1.00 | — | 1.00 | 1.00 |
| | Lauryl acrylate | | 4.00 | — | — | — | — | — |
| | 4-Hydroxybutyl acrylate | | — | — | — | 1.00 | — | — |
| Component | 2,4,6-Trimethylbenzoyl- | | 2.00 | 0.40 | 0.40 | 0.40 | — | 0.40 |
| (B) | diphenylphosphine oxide | | | | | | | |
| | Bis(2,4,6-trimethylbenzoyl)- | | — | — | — | — | 0.40 | — |
| | phenylphosphine oxide | | | | | | | |
| Component | Butadiene rubber | | 71.00 | 4.00 | 51.92 | 51.92 | 4.00 | 4.00 |
| (C) | Poly(1-decene) | | — | 50.00 | 19.08 | 19.08 | 50.00 | 50.00 |
| Component | D1 | IRGANOX 1010 | — | 1.00 | — | — | — | — |
| (D) | | ADEKA STAB AO-30 | — | — | — | — | — | — |
| | | ADEKA STAB AO-80 | — | — | — | — | — | — |
| | | IRGANOX 1520L | 1.00 | — | — | — | — | — |
| | D2 | SUMILIZER^{(R)} TPL-R | — | — | — | — | — | — |
| | | SUMILIZER^{(R)} TPM | — | — | — | — | — | — |
| | | SUMILIZER^{(R)} TPD | — | — | — | — | — | — |
| | | ADEKA STAB AO-503 | — | — | — | — | 1.00 | — |

| | | | | | | | |
|---|---|---|---|---|---|---|---|
| Properties | Concentration of | 2.6 | 1.2 | 1.0 | 1.0 | 1.2 | 1.2 |
| | (Meth)acryloyl group | | | | | | |
| | (10⁻⁴ mol/g) | | | | | | |
| | Viscosity (mPa · s) | 3400 | 3100 | 3200 | 3200 | 3050 | 3200 |
| | Bleedout | A | A | F | F | B | B |
| | Resistance to yellowing | A | F | F | F | F | F |
| | Modulus of elasticity of | 11000 | 78000 | 12000 | 11000 | 77000 | 79000 |
| | cured material (Pa) | | | | | | |
| | Curing properties at low dose | F | A | A | A | A | A |
| | Shaded part curing (mm) | 4.0 | 9.5 | 9.5 | 9.5 | 10.0 | 10.5 |
| | Moist heat resistance | A | A | A | A | A | A |
| | reliability | | | | | | |
| | Curing shrinkage ratio (%) | 0.8 | 0.8 | 0.7 | 0.7 | 0.8 | 0.8 |

The resin compositions of Examples 1 to 9 are free from the bleedout, have an appropriate viscosity, and are excellent in curing properties at a low dose and shaded part curing properties. The cured materials of the subject resin compositions are favorable in both the modulus of elasticity and the moist heat resistance reliability. In addition, in Example 9 using a compound not containing a thioether group as the antioxidant, though yellowing is observed, it is also understood that this yellowing is suppressed by using a compound having a thioether group.

Furthermore, due to the fact that the resin compositions have an appropriate concentration of (meth)acryloyl group, when used for a structural member of an image display device, display unevenness such as color unevenness development was not generated.

On the other hand, because the cured materials of the resin compositions of Comparative Examples 1 to 4 do not use a hindered phenol-based compound as the antioxidant or use other antioxidants, the bleedout was generated.

### INDUSTRIAL APPLICABILITY

The photocurable liquid resin composition of the present invention has an appropriate viscosity and is excellent in curing properties at a low dose and shaded part curing properties, and the cured material of the subject resin composition is favorable in the moist heat resistance reliability. In addition, the subject cured material has an appropriate modulus of elasticity and a decreased content of a (meth)acryloyl group, and therefore, when used as a structural member of an image display device, it is able to suppress the generation of display unevenness.

In view of the foregoing properties, the photocurable liquid resin composition of the present invention may be suitably used as a structural member for the purpose of filling a space between a protective panel and an image display unit or the like in an image display device such as a liquid crystal display device.

### REFERENCE SIGNS LIST

1: Image display unit
10: Liquid crystal display cell
20, 22: Polarizing plate
30: Touch panel
31, 32: Transparent resin layer
40: Transparent protective substrate
50: Backlight system
60: Test sample
61: Light shielding mask
62a, 62b: PET film
63: Resin composition
63a: Cured portion of resin composition
63b: Uncured portion of resin composition

1. A photocurable liquid resin composition comprising a compound having a (meth)acryloyl group, a photopolymerization initiator, a plasticizer, and an antioxidant, the component including a compound having a hindered phenol structure in a molecule thereof.

2. The photocurable liquid resin composition according to claim 1, wherein the compound of is a compound further having a thioether structure.

3. The photocurable liquid resin composition according to claim 1, which further includes a compound having a thioether structure in addition to the compound of as the component.

4. The photocurable liquid resin composition according to claim 1, which includes an isoprene polymer having a (meth)acryloyl group as the component.

5. The photocurable liquid resin composition according to claim 1, wherein a content of the component is 10% by mass to 90% by mass relative to the total amount of the resin composition.

6. The photocurable liquid resin composition according to claim 1, which includes a polymer having a (meth)acryloyl group in a molecule thereof and a monomer having one (meth)acryloyl group in a molecule thereof as the component.

7. The photocurable liquid resin composition according to claim 6, wherein a content of the component in the total amount of the resin composition is 0.5% by mass to 10% by mass.

8. The photocurable liquid resin composition according to claim 1, which does not substantially contain an organic solvent and has a viscosity at 25° C. of from 5.0×10² mPa·s to 5.0×10³ mPa·s.

9. An image display device having a laminate structure comprising an image display unit having an image display part, a protective panel, and a resin layer existent between the image display unit and the protective panel, the resin layer being composed of a cured material of the resin composition according to claim 1.

10. An image display device having a laminate structure comprising an image display unit having an image display part, a touch panel, a protective panel, and a resin layer existent between the image display unit and the touch panel, or between the touch panel and the protective panel, the resin layer being composed of a cured material of the resin composition according to claim 1.

11. A method for manufacturing an image display device including an image display unit and a protective panel, the method comprising a step of allowing the resin composition according to claim 1 to intervene between the image display unit and the protective panel; and a step of performing irradiation with light from the side of the protective panel surface, to cure the resin composition.

12. A method for manufacturing an image display device including an image display unit, a touch panel, and a protective panel, the method comprising a step of allowing the resin composition according to claim 1 to intervene between the image display unit and the touch panel, or between the touch panel and the protective panel; and a step of performing irradiation with light from the side of the protective panel surface, to cure the resin composition.
